(19) United States
(12) Patent Application Publication
(10) Pub. No.: US 2024/0327274 A1
(43) Pub. Date: Oct. 3, 2024

(54) COATING COMPOSITION HAVING HIGH LIGHT TRANSMITTANCE, COATING GLASS AND METHOD FOR MANUFACTURING THE SAME, COOKING USING THE SAME

(71) Applicant: LG ELECTRONICS INC., Seoul (KR)

(72) Inventors: Ju Hyeong KIM, Seoul (KR); Hyunwoo Jun, Seoul (KR); Taehee Kim, Seoul (KR); Jaeyoung Shin, Seoul (KR); Yongsoo Lee, Seoul (KR)

(21) Appl. No.: 18/617,867

(22) Filed: Mar. 27, 2024

(30) Foreign Application Priority Data
Mar. 31, 2023 (KR) 10-2023-0042653

(51) Int. Cl. C03C 17/04; C03C 3/066; C03C 8/08; F24C 15/00; F24C 15/04

(52) U.S. Cl. CPC C03C 17/04; C03C 3/066; C03C 8/08; F24C 15/005; F24C 15/04; C03C 2207/00

(57) ABSTRACT

A coating composition, a coating glass, a method for preparing a coating composition, and cooking appliances using a coating composition. More specifically, the coating composition may include 20 to 40% by weight of Phosphorus Pentoxide (P₂O₅), 10 to 25% by weight of 10 to 25% by weight of Aluminum Oxide (Al₂O₃), 1 to 5% by weight of Zirconium Dioxide (ZrO₂), 10 to 30% by weight of at least one of Sodium Oxide (Na₂O) and Potassium Oxide (K₂O), 5 to 20% by weight of Boric Oxide (B₂O₃), 5 to 15% by weight of Zinc Oxide (ZnO), and 3 to 10% by weight of Silicon Dioxide (SiO₂). Thus, the coating composition has high light transmittance, and excellent cleaning performance.

### CROSS-REFERENCE TO RELATED APPLICATION(S)

This application claims priority from Korean Patent Application No. 10-2023-0042653, filed in Korea on Mar. 31, 2023 in the Korean Intellectual Property Office, and all the benefits accruing therefrom under 35 U.S.C. 119, the contents of which are herein incorporated by reference in their entirety.

### BACKGROUND

### 1. Field

A coating composition, a coating glass, and a method for manufacturing a coating composition, and cooking appliances using a coating composition are disclosed herein.

### 2. Background

Cooking appliances, such as electric ovens and gas ovens, are devices that cook food or other items (hereinafter, collectively “food”) using a heating source. As contaminants generated during a cooking process stick to an inner wall of a cavity and an inner surface of a door of the cooking appliance, it is necessary to clean the inner wall of the cavity and the inner surface of the door. In this regard, a coating layer is formed on the inner wall surface of the cavity of the cooking appliance or the inner surface of the door thereof to facilitate removal of the contaminants on the cooking appliance.

The door of the cooking appliance is provided with a door glass that allows an interior of the cooking appliance to be visually identified by the user. The contaminants generated during the cooking process may also stick to the door glass. In order to easily clean the door glass surface, the coating layer may be formed on an inner surface of the door glass. Because existing coating layers have low light transmittance, the interior of the cooking appliance cannot be clearly identified with the naked eye. Accordingly, a coating composition that allows the interior of the cooking appliance to be clearly identified is required.

Moreover, the contaminants on an existing coating may be cleaned under high temperature or water soaking condition. However, it is difficult to apply the high temperature or water soaking condition to the door glass. Accordingly, a coating composition that may allow the contaminants on the door glass to be easily cleaned without the need for conditions, such as high temperature or water soaking, is required.

Further, a manufacturing method that may easily form a coating layer on a glass substrate, such as the door glass of the cooking appliance, is required. Furthermore, the coating layer applied to the glass substrate, such as the door glass of cooking appliances, uses an additive, such as nano powders, to achieve high light transmittance. However, conventional coating layers have an increased cost due to the additive.

### BRIEF DESCRIPTION OF THE DRAWINGS

Embodiments will be described in detail with reference to the following drawings in which like reference numerals refer to like elements, and wherein:

FIG. 1 is a front view of a cooking appliance according to an embodiment;

FIG. 2 is an enlarged cross-sectional view of a portion of an inner surface of a door glass of the cooking appliance of FIG. 1; and

FIG. 3 is a photograph showing light transmittance for Examples using a coating composition according to embodiments and Comparative Examples.

### DETAILED DESCRIPTION

Embodiments will be described hereinafter, so that a person skilled in the art in the technical field to which the embodiments belong will be able to easily implement the technical ideas. When describing the embodiments, upon determination that description of known technology related to the embodiments may unnecessarily obscure the gist, such description is omitted. Hereinafter, embodiments will be described with reference to the drawings.

Embodiments are not limited to the embodiments disclosed hereinafter and may be implemented in various forms. The embodiments are set forth to ensure that disclosure is complete, and thus, to provide the scope for those skilled in the art. Hereinafter, a coating composition, a coating glass, a method for preparing a coating composition, and a cooking appliance using a coating composition according to embodiments will be described.

The coating composition according to an embodiment may include 20 to 40% by weight of Phosphorus Pentoxide (P₂O₅), 10 to 25% by weight of Aluminum Oxide (Al₂O₃), 1 to 5% by weight of Zirconium Dioxide (ZrO₂), 10 to 30% by weight of at least one of Sodium Oxide (Na₂O) and Potassium Oxide (K₂O), 5 to 20% by weight of Boric Oxide (B₂O₃), 5 to 15% by weight of Zinc Oxide (ZnO), and 3 to 10% by weight of Silicon Dioxide (SiO₂).

P₂O₅ is an ingredient that functions to form a glass structure. Moreover, P₂O₅ is a glass former that facilitates the addition of a large amount of a transition metal oxide to the coating composition, and has the function of easily removing contaminants by helping water penetrate between a surface of the coating and contaminants. In addition, in accordance with embodiments, P₂O₅ has the function of increasing light transmittance of the coating. The coating composition may contain P₂O₅ in a range of 20 to 40% by weight. If the content of the P₂O₅ exceeds 40% by weight, vitrification of the coating composition may not be achieved, and thermal properties of the coating composition may deteriorate. Conversely, if the content of P₂O₅ is smaller than 20% by weight, the light transmittance and a cleaning function of the coating may be reduced.

Al₂O₃ and ZrO₂ are ingredients that complement weak durability of phosphate-based glass and improve a surface hardness of the coating. The coating composition of embodiments may include 10 to 25% by weight of Al₂O₃ and 1 to 5% by weight of ZrO₂. If the content of each of Al₂O₃ and ZrO₂ exceed the maximum content, adhesion of the coating may decrease and light transmittance may decrease. Conversely, if the content of each of Al₂O₃ and ZrO₂ content is smaller than a minimum content, physical and chemical durability of the coating may be reduced.

The coating composition may include Al₂O₃ in a larger amount than that of ZrO₂. In accordance with embodiments, when Al₂O₃ is contained in an amount of 15 to 24 weight, and ZrO₂ is contained in an amount of 2 to 3% by weight, the light transmittance and durability of the coating are most desirable. In particular, ZrO₂ should be contained at 2 to 3% by weight to maintain excellent physical and chemical durability of the coating without decreasing the transmittance of the coating.

Na₂O and K₂O play a role in improving a cleaning performance of the coating composition and lowering a firing temperature of the coating composition. The coating composition may include at least one of the above Na₂O and K₂O in a range of 10 to 30% by weight. If a total content of at least one of Na₂O and K₂O exceeds 30% by weight, there is a problem in that the firing temperature of the coating composition is not lowered, and a coating performance deteriorates. Conversely, if the total content of at least one of Na₂O and K₂O is smaller than 10% by weight, the cleaning performance may be deteriorated.

The coating composition may include Na₂O in a larger amount than that of the K₂O. In accordance with embodiments, when Na₂O is contained in an amount of 5 to 20% by weight and K₂O is contained in an amount of 5 to 10% by weight, the cleanability of the coating may be excellent and low temperature firing may be realized.

B₂O₃ acts as a glass former and ensures that the components of the coating composition are dissolved uniformly. Moreover, B₂O₃ improves physical and thermochemical durability of the coating. The coating composition may include B₂O₃ in the range of 5 to 20% by weight. If the content of the B₂O₃ exceeds 20% by weight, it may interfere with the addition of other ingredients, resulting in a decrease in cleaning performance and inability to achieve high light transmittance. Conversely, if the content of B₂O₃ is smaller than 5% by weight, the glass composition may collapse and crystallization of the glass may occur.

ZnO is an ingredient that increases the light transmittance of the coating composition. The coating composition according to embodiments may contain 5 to 15% by weight of ZnO. The coating composition according to embodiments may include a relatively large amount of ZnO compared to existing coating compositions. This is to maximize the light transmittance of the coating. Moreover, the coating composition according to embodiments maximizes light transmittance while also providing excellent cleanability and durability by controlling the composition of other ingredients except ZnO. If the content of ZnO is smaller than 5% by weight, high light transmittance cannot be achieved. Conversely, if the content of ZnO exceeds 15% by weight, it may interfere with the addition of other ingredients, reducing the cleaning performance and durability of the coating.

As the content of ZnO among the components of the coating composition increases, a thermal expansion coefficient of the coating increases, and the coating may crack. Moreover, due to a chemical imbalance caused by the increase in the ZnO content, the coating layer may be dissolved in acidic or basic solutions to leave a trace. In order to improve this problem, the coating composition according to embodiments may contain ZnO at an appropriate content as described above. ZnO is a component that easily causes glass to crystallize. The coating composition according to embodiments contains ZnO in the appropriate amount to solve the problem of leaving the trace when the coating composition is dissolved in acidic or basic solutions.

In addition, the coating composition in accordance with this embodiment may contain 3 to 10% by weight of SiO₂. SiO₂ is an important component that inhibits crystallization in the composition of the present disclosure. In particular, a crystalline phase is formed in the coating layer at a temperature of 600 to 700° C. as the coating temperature, such that haze is generated. However, high visibility may be achieved by including additives, such as nano powders, in the coating composition constituting the coating layer to suppress or prevent crystal phase precipitation. However, according to embodiments, the additive, such as nano powders, is excluded, but SiO₂ is used to secure the high visibility while suppressing or preventing the crystal phase precipitation of the coating layer. However, adding a small amount of SiO₂ to the phosphate-based glass coating composition may cause devitrification of the glass. Moreover, when a coating composition that does not include SiO₂ is coated on a soda-lime glass (glass containing about 70 wt % SiO₂) substrate, the SiO₂ crystal phase is generated during the process of firing the coating composition. The coating composition in accordance with this embodiment may contain 3% or greater by weight of SiO₂ to prevent devitrification of the glass and suppress or prevent precipitation of the crystal phases during the firing process. However, if the content of SiO₂ exceeds 10% by weight, the light transmittance of the coating may decrease and physical and chemical durability may decrease. The coating composition according to this embodiment may contain SiO₂ which acts as a nucleating agent in the above-mentioned content range such that high light transmittance may be achieved while securing physical and thermal durability.

In addition, the coating composition according to embodiments may further contain Li₂O at 3% by weight or smaller, and may further contain at least one of BaO and CaO in an amount of up to 5 weight. One or more of Li₂O, BaO, and CaO may control thermal properties, such as a thermal expansion coefficient, heat resistance, and the firing temperature of the coating. If the content of Li₂O exceeds 3% by weight, or if the total content of at least one of BaO and CaO exceeds 5% by weight, the addition of other components may be prevented such that high permeability may not be achieved.

The coating composition according to embodiments has a novel composition ratio of the components as mentioned above, and thus, may implement a coating with high light transmittance and excellent cleaning properties even without including the additive, such as nano powders. In addition, the coating composition according to embodiments has thermal properties such that the composition is able to be successfully fired at a temperature of 700° C. or lower.

A method for manufacturing a coating glass according to embodiments may include providing a substrate including glass; applying a coating composition on the substrate; heat-treating the substrate and the coating composition; and cooling the substrate and the coating composition. The heat-treating of the substrate and the coating composition may be performed at a temperature of 700° C. or lower. The coating composition may include a coating composition according to embodiments as described above.

The substrate may be embodied as a tempered glass to be applied to home appliances, such as cooking appliances. In addition, as described above, the coating composition according to embodiments has thermal properties such that the coating composition is able to be successfully fired at a temperature of 700° C. or lower. Accordingly, the substrate and the coating composition may be heat-treated at a temperature of 700° C. or lower, so that a strengthening treatment of the substrate and the firing of the coating composition may be performed simultaneously.

The coating glass manufactured from the above manufacturing method has a visible light transmittance of 80% or higher.

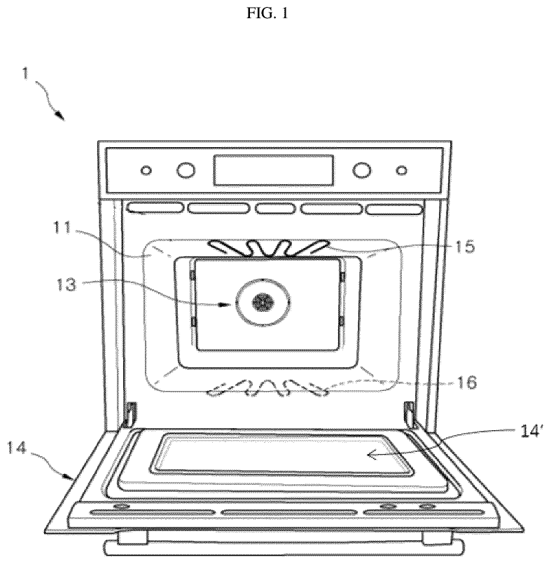

Referring to FIG. 1, a cooking appliance 1 according to embodiments may include a cavity 11 in which a cooking chamber is formed, and a door 14 configured to selectively open and close the cooking chamber. The door 14 may include a door glass 14′ with a coating layer 17 formed on one surface thereof. The coating layer 17 may include the coating composition as described above.

More specifically, referring to FIG. 1, the cooking appliance 1 according to embodiments may include at least one heating source 13, 15, and 16 that provides heat for heating a heating target in the cooking chamber, in addition to the cavity 11 in which the cooking chamber is formed, and the door 14 configured to selectively open and close the cooking chamber.

The cavity 11 may be formed in a hexahedral shape with an open front surface. The heating source 13, 15, and 16 may include a convection assembly 13 that discharges heated air into the cavity 11, an upper heater 15 disposed at a top of the cavity 11, and a lower heater 16 disposed at a bottom of the cavity 11. Each of the upper heater 15 and the lower heater 16 may be provided in or out of the cavity 11. The heating source 13, 15, and 16 does not necessarily include the convection assembly 13, the upper heater 15, and the lower heater 16. That is, the heating source 13, 15, and 16 may include at least one of the convection assembly 13, the upper heater 15, and the lower heater 16.

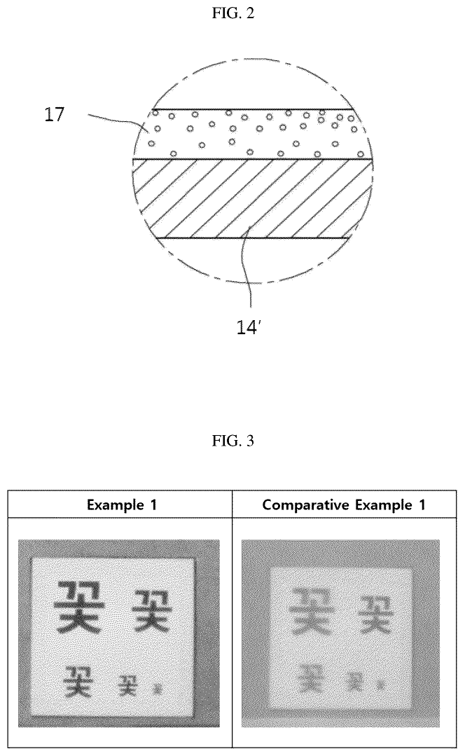

Referring to FIG. 2, the coating composition according to embodiments may be coated on one surface of the door glass 14′.

Hereinafter, specific aspects of the embodiments will be described through Examples.

As shown in Table 1 below, coating composition materials according to Examples (prepared according to embodiments disclosed herein) and Comparative Examples were prepared.

In this regard, Ammonium Dihydrogen Phosphate (NH₄H₂PO₄) was used as a raw material for Phosphorus Pentoxide (P₂O₅), and Sodium Carbonate (Na₂CO₃), Potassium Carbonate (K₂CO₃), and Lithium Carbonate (Li₂CO₃) were used as raw materials for Na₂O, K₂O, and Li₂O, respectively. Moreover, Barium Carbonate (BaCO₃) and Calcium Carbonate (CaCO₃) were used as raw materials for BaO and CaO, respectively, and the remaining ingredients were the same as those shown in Table 1 below.

The materials listed in Table 1 were melted at 1300° C. for 30 minutes and then quenched. Then, the quenched material was pulverized so that a D50 of the pulverization product was smaller than 10 μm.

Next, the pulverization product was mixed with ethylcellulose and the mixture was homogenized in a 3-roll mill to produce a paste containing the coating composition.

Next, the paste was applied on soda lime glass with a size of 200×200 (mm) and a thickness of 5T and was heat-treated at 700° C. for 5 minutes to manufacture the coating glass.

TABLE 1

| | | | | | Comparative | |
|---|---|---|---|---|---|---|
| Ingredients | Examples | | | | Examples | |
| (Wt %) | 1 | 2 | 3 | 4 | 1 | 2 |
| P₂O₅ | 32.3 | 31 | 31 | 31 | 34 | 45 |
| Al₂O₃ | 21 | 19 | 19 | 19 | 22.8 | 40 |
| B₂O₃ | 11.3 | 11 | 11 | 11 | 11.3 | 5 |
| Na₂O | 7.9 | 13 | 13 | 13.75 | 8 | 0 |
| K₂O | 7 | 8 | 8 | 8 | 7.5 | 0 |
| Li₂O | 1 | 2 | 3 | 2 | 0.2 | 0 |
| ZnO | 7.7 | 9 | 8.5 | 10 | 7.2 | 6 |
| ZrO₂ | 2.4 | 2 | 2 | 2 | 2.4 | 1 |
| BaO | 1.8 | 0.75 | 0 | 0 | 1.4 | 2 |
| CaO | 1.7 | 0.25 | 0 | 0.25 | 1 | 1 |
| SiO₂ | 5.9 | 4 | 4.5 | 3 | 0 | 0 |

Performance evaluation was performed on specimens according to Examples (prepared according to embodiments disclosed herein) and Comparative Examples as follows.

### 1. Vitrification Characteristics of Coating Layer and Whether Coating Layer is Damaged

The vitrification characteristics of the coating layer were measured based on whether a crystalline shape of the coating layer made of the coating composition had been formed.

Moreover, damage to the coating layer was measured based on whether cracks had occurred in the coating layer formed on the glass as a base material.

TABLE 2

| Examples | Vitrification | Damage to coating layer |
|---|---|---|
| Example 1 | ◯ | X |
| Example 2 | ◯ | X |
| Example 3 | ◯ | X |
| Example 4 | ◯ | X |
| Comparative Example 1 | ◯ | ◯ |
| Comparative Example 2 | X | X |

Referring to Table 2, it may be identified that in each of Example 1 to Example 4, the coating layer is formed in an amorphous state, and no cracks occur in the coaching layer formed on the base material.

However, it may be identified that in Comparative Example 2, the coating layer has a crystalline shape due to the increase in the content of Al₂O₃, and thus, the vitrification is not achieved. Moreover, it may be identified that in Comparative Example 2, the coating layer is damaged due to cracks occurring in the coating layer when the coating layer is formed on the base material due to a difference between thermal expansion coefficients of the base material glass and the coating composition.

### 2. Firing Temperature Measurement of Coating Layer

Whether the coating layer had been successfully fired was measured based on whether the coating layer has been successfully fired at a temperature of approximately 700° C. as a strengthening temperature of the glass as the base material. When the glass as the base material is applied to the cooking appliances, a strengthening process is performed to increase a strength of the glass for user safety. A firing process of the coating layer is carried out simultaneously with the strengthening process of the base material as the glass.

At this time, whether the coating layer had been successfully fired was measured based on whether the coating layer has been successfully fired at the strengthening temperature of the glass.

TABLE 3

| | Whether coating layer had |
|---|---|
| Examples | been successfully fired |
| Example 1 | ◯ |
| Example 2 | ◯ |
| Example 3 | ◯ |
| Example 4 | ◯ |
| Comparative Example 1 | ◯ |
| Comparative Example 2 | X |

Referring to Table 3, it may be identified that the coating layer according to each of Example 1 to Example 4 is successfully fired at a temperature of about 700° C. which is the glass strengthening heating temperature. Accordingly, the firing of the coating layer according to each of Example 1 to Example 4 may be simultaneously performed along with the glass strengthening process. Thus, a separate coating layer firing process may be omitted, thereby improving process efficiency.

When the coating layer is formed after the strengthening process, a chemical bond of the tempered glass may be broken due to the firing temperature of the coating layer. However, the coating layer according to each of Example 1 to Example 4 may be successfully fired simultaneously with the glass strengthening process. Thus, the above problem may be solved.

On the other hand, it may be identified that the coating layer according to each of Comparative Example 1 to Comparative Example 2 is not successfully fired at a temperature of about 700° C. which is the glass reinforcement heating temperature. That is, it may be identified that the firing temperature of the coating composition of the coating layer according to Comparative Example 1 to Comparative Example 2 exceeds 700° C.

Accordingly, the coating layer according to Comparative Example 1 to Comparative Example 2 cannot be successfully fired simultaneously with the glass strengthening process. Thus, a separate coating layer firing process is required, which may reduce process efficiency. Moreover, as the coating layer should be formed after the strengthening process, the chemical bond of the tempered glass may be broken under the firing temperature of the coating layer which may reduce the strength of the glass.

### 3. Light Transmittance Measurement of Coating Layer

The light transmittance of the coating layer was measured in the visible light region with a wavelength range of about 380 nm to about 780 nm using a UV visible meter. The visible light transmittance of the glass as the base material before coating the coating layer thereon was about 80%. After forming the coating layer thereon, the visible light transmittance of the glass with the coating layer formed thereon was measured using the above measuring device.

TABLE 4

| Examples | Visible light transmittance (%) |
|---|---|
| Example 1 | 86 |
| Example 2 | 85.4 |
| Example 3 | 85.7 |
| Example 4 | 85.5 |
| Comparative Example 1 | 83 |
| Comparative Example 2 | 20 |

TABLE 5

| Examples | Haze(%) |
|---|---|
| Example 1 | 3.8 |
| Comparative Example 1 | 21.3 |

Referring to Table 4, it may be identified that the tempered glass with the coating layer of each of Example 1 to Example 4 has a visible light transmittance of 85% or higher. In other words, it may be identified that when the tempered glass with the coating layer formed thereon is applied to the cooking appliance, for example, an internal state thereof may be easily and clearly identified with the naked eye from the outside.

On the other hand, it may be identified that the tempered glass with the coating layer of Comparative Example 2 formed thereon has low visible light transmittance. That is, it may be identified that when the tempered glass with the coating layer formed thereon is applied to the cooking appliance, for example, it is difficult to easily identify the internal state of the appliance from the outside with the naked eye.

In addition, referring to FIG. 3, Example 1 of embodiments has high light transmittance and low haze. Thus, the inside of the appliance may be clearly identified with the naked eye. However, Comparative Example 1 has high light transmittance but high haze. Thus, the inside of the appliance cannot be clearly identified with the naked eye.

### 4. Cleanability Measurement

The cleanability of the coating layer was measured by the following method.

After washing a surface of the coating layer with distilled water or alcohol, a jig for applying contaminants was placed on the coating layer, and then a contaminant was thinly applied, with a brush, to an area of 10 mm×10 mm of the coating layer and fixed thereto. The contaminant was Monster Mash or chicken oil.

Afterwards, hardened contaminants were wiped with a wet scrubber with a force of 3 kgf or smaller, and the number of cleaning round trips of the scrubber was measured as shown in Table 5, and was defined as the number of cleaning times. The evaluation indicators were as shown in Table 6 below.

TABLE 6

| Number of cleaning round trips of scrubber | Performance level |
|---|---|
| 5 or smaller | 5 |
| 10 or smaller | 4 |
| 15 or smaller | 3 |
| 25 or smaller | 2 |
| Exceeding 25 | 1 |

TABLE 7

| Examples | Cleaning performance |
|---|---|
| Example 1 | 5 |
| Example 2 | 5 |
| Example 3 | 5 |
| Example 4 | 5 |
| Comparative Example 1 | 4 |
| Comparative Example 2 | 1 |

Referring to Tables 5 and 6, it may be identified that the tempered glass with the coating layer according to each of Example 1 to Example 4 formed thereon has improved cleaning ability. In other words, it may be identified that the coating layer according to each of Example 1 to Example 4 had maximized hydrophilicity due to an optimal range of the composition ratio of the coating composition, such that the contaminants attached to the surface of the coating layer may be easily removed with only a wet scrubber.

The coating layer of the above examples has improved hydrophilicity. Accordingly, during water washing, water may effectively penetrate into the interface between the coating layer and the contaminants on the coating layer, so that contaminants may be easily removed from the coating layer.

On the other hand, the coating layer according to Comparative Example 2 has a low hydrophilicity. Accordingly, it was difficult to remove the contaminants from the coating layer of Comparative Examples using only a wet scrubber.

Embodiments disclosed herein provide a novel coating composition with high light transmittance. Moreover, embodiments disclosed herein provide a novel coating composition from which contaminants may be entirely removed with just a wet scrub brush.

Further, embodiments disclosed herein provide a method for coating a coating composition on a glass substrate, such as a door glass of a cooking appliance, through a simple process. Furthermore, embodiments disclosed herein provide a novel coating composition that may achieve high light transmittance without an additional additive.

A coating composition according to embodiments disclosed herein to achieve the purpose as described above contains P₂O₅, Al₂O₃ and/or ZrO₂, Na₂O and/or K₂O, B₂O₃, ZnO, and SiO₂ in appropriate contents. More specifically, the coating composition according to embodiments disclosed herein has high light transmittance and excellent cleaning performance because the above mentioned components have respective functions while maintaining balance therebetween within the composition.

A coating composition according to embodiments disclosed herein may include 20 to 40% by weight of P₂O₅; 10 to 25% by weight of Al₂O₃; 1 to 5% by weight of ZrO₂; 10 to 30% by weight of at least one of Na₂O and K₂O; 5 to 20% by weight of B₂O₃; 5 to 15% by weight of ZnO; and 3 to 10% by weight of SiO₂.

A method for manufacturing a coating glass according to embodiments disclosed herein may include heat-treating a glass substrate and the coating composition at a temperature of 700° C. or lower, so that the coating composition may be successfully fired simultaneously with a strengthening process of the glass substrate.

The coating composition according to embodiments disclosed herein has a higher light transmittance compared to existing coating compositions. Accordingly, the inner space inwardly of the door to which the coating composition of embodiments disclosed herein has been applied is clearly visible to the naked eye.

Moreover, the coating composition according to embodiments disclosed herein has high light transmittance and allows the contaminants thereon to be easily removed therefrom without high temperature or water soaking conditions. In addition, the coating composition in accordance with embodiments disclosed herein may exhibit equal or superior high light transmittance to that when using an additive for improving light transmission such as nano powders, even without using the additive.

The manufacturing method according to embodiments disclosed herein may coat the coating composition on a glass substrate, such as the door glass of the cooking appliance, through a simple process. Accordingly, the coating glass substrate, such as the door glass of the cooking appliances, may be manufactured simply at a low cost.

Although the embodiments have been described with reference to the accompanying drawings, the embodiments are not necessarily limited to these embodiments, and may be modified in a various manner within the scope of the technical spirit of the present disclosure.

Accordingly, the embodiments as disclosed are intended to describe rather than limit the technical idea, and the scope of the technical idea is not limited by these embodiments. Therefore, it should be understood that the embodiments described above are not restrictive but illustrative in all respects. In addition, even though an effect of a configuration of the present disclosure is not explicitly described in describing the embodiments above, it is obvious that the predictable effect from the configuration should be recognized.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A coating composition, comprising:
20 to 40% by weight of Phosphorus Pentoxide (P₂O₅);
10 to 25% by weight of Aluminum Oxide (Al₂O₃);
1 to 5% by weight of Zirconium Dioxide (ZrO₂);
10 to 30% by weight of at least one of Sodium Oxide (Na₂O) and Potassium Oxide (K₂O);
5 to 20% by weight of Boric Oxide (B₂O₃);
5 to 15% by weight of Zinc Oxide (ZnO); and
3 to 10% by weight of Silicon Dioxide (SiO₂).

2. A cooking appliance, comprising:
a cavity in which a cooking chamber is defined; and
a door configured to selectively open and close the cooking chamber, wherein the door includes a door glass having a coating layer formed on one surface thereof, and wherein the coating layer includes the coating composition of claim 1.

3. The cooking appliance of claim 2, wherein the door glass has transmittance of 85% or greater of visible light.

4. The coating composition of claim 1, wherein the coating composition further comprises:
3% by weight or smaller of Lithium Oxide (Li₂O); and
5% by weight or smaller of at least one of Barium Oxide (BaO) and Calcium Oxide (CaO).

5. A cooking appliance, comprising:
a cavity in which a cooking chamber is defined; and
a door configured to selectively open and close the cooking chamber, wherein the door includes a door glass having a coating layer formed on one surface thereof, and wherein the coating layer includes the coating composition of claim 4.

6. The cooking appliance of claim 5, wherein the door glass has transmittance of 85% or greater of visible light.

7. The coating composition of claim 1, wherein a content of the Al₂O₃ is in a range of 15 to 24% by weight, and wherein a content of the ZrO₂ is in a range of 2 to 3% by weight.

8. A cooking appliance, comprising:
a cavity in which a cooking chamber is defined; and
a door configured to selectively open and close the cooking chamber, wherein the door includes a door glass having a coating layer formed on one surface thereof, and wherein the coating layer includes the coating composition of claim 7.

9. The cooking appliance of claim 8, wherein the door glass has transmittance of 85% or greater of visible light.

10. The coating composition of claim 1, wherein a content of the Na₂O is in a range of 5 to 20% by weight, and wherein a content of the K₂O is in a range of 5 to 10% by weight.

11. A cooking appliance, comprising:
a cavity in which a cooking chamber is defined; and
a door configured to selectively open and close the cooking chamber, wherein the door includes a door glass having a coating layer formed on one surface thereof, and wherein the coating layer includes the coating composition of claim 10.

12. The cooking appliance of claim 11, wherein the door glass has transmittance of 85% or greater of visible light.

13. The coating composition of claim 1, wherein a firing temperature of the coating composition is 700° C. or lower.

14. A cooking appliance, comprising:
a cavity in which a cooking chamber is defined; and
a door configured to selectively open and close the cooking chamber, wherein the door includes a door glass having a coating layer formed on one surface thereof, and wherein the coating layer includes the coating composition of claim 13.

15. The cooking appliance of claim 14, wherein the door glass has transmittance of 85% or greater of visible light.

16. A method for manufacturing a coating glass, the method comprising:
providing a substrate including glass;
applying a coating composition on the substrate;
heat-treating the substrate and the coating composition; and
cooling the substrate and the coating composition, wherein the heat-treating of the substrate and the coating composition is performed at a temperature of 700° C. or lower, and wherein the coating composition comprises:
20 to 40% by weight of Phosphorus Pentoxide (P₂O₅);
10 to 25% by weight of Aluminum Oxide (Al₂O₃);
1 to 5% by weight of Zirconium Dioxide (ZrO₂);
10 to 30% by weight of at least one of Sodium Oxide (Na₂O) and Potassium Oxide (K₂O);
5 to 20% by weight of Boric Oxide (B₂O₃);
5 to 15% by weight of Zinc Oxide (ZnO); and
3 to 10% by weight of Silicon Dioxide (SiO₂).

17. The method of claim 16, wherein the coating composition further comprises:
3% by weight or smaller of Lithium Oxide (Li2O); and
5% by weight or smaller of at least one of Barium Oxide (BaO) and Calcium Oxide (CaO).

18. The method of claim 16, wherein a content of the Al₂O₃ in the coating composition is in a range of 15 to 24% by weight, and wherein a content of the ZrO₂ in the coating composition is in a range of 2 to 3% by weight.

19. The method of claim 16, wherein a content of the Na₂O in the coating composition is in a range of 5 to 20% by weight, and wherein a content of the K₂O in the coating composition is in a range of 5 to 10% by weight.

20. The method of claim 16, wherein the coating glass has a transmittance of 85% or greater of visible light.

21. A coating composition made using the method of claim 16.
